(19) United States
(12) Patent Application Publication
(10) Pub. No.: US 2009/0327869 A1
(43) Pub. Date: Dec. 31, 2009

(54) ONLINE AD SERVING

(75) Inventors: Xiaofeng Fan, Redmond, WA (US); John D. Dunagan, Bellevue, WA (US); Helen J. Wang, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,620

(22) Filed: Jun. 27, 2008

(51) Int. Cl. G06F 17/00

(52) U.S. Cl. 715/240

(57) ABSTRACT

Online ad hosting (e.g., hosting ads from one domain on a webpage from a different domain) is accomplished using an insulator cross-domain frame (e.g., an inline frame (IFrame)), into which a third party may load content, source code to detect events associated with the third party content (e.g., detecting if ad content wishes to expand), and a communicator same-domain IFrame for sending requests to the host webpage associated with detected events. That is, a cross-domain IFrame may be created in a host webpage, which can isolate an ad from the host webpage. A communicator frame may be utilized to communicate text messages between the contents of the cross-domain frame and the host webpage. Further, an API can be used to apply parameters, restrictions and allowable events to the third party content in the insulator IFrame.

### BACKGROUND

In a computing environment, websites and associated webpages often host online advertisements, intended to be viewed by online users of the respective websites. Online advertisements typically come from a different domain than that of the hosting website. Online advertisers and hosting websites typically work with an ad syndicator, which takes calls for ads from the host, pulls ads from the advertiser, and then directs the ads to the host's website. Often, online ads have rich functionality, including an ability to expand and/or move about a webpage.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Typically, when a webpage wishes to display an online ad, the webpage (host webpage) can call to an ad syndicator, indicating specifications for an open ad-space in the host webpage. The ad syndicator can pull an ad from a catalogue of ads supplied by advertisers, which meets the specifications supplied by the host webpage. Typically, the ad syndicator will put the pulled ad directly into the host webpage, in such a way that the browser takes the ad as a part of the host webpage. When this occurs, the ad is often allowed to freely interact with the host webpage in order to provide for rich functionality, including changing its size and/or position on the host webpage. However, inserting the ad in this manner also grants the ad many if not all privileges that the host webpage may have in the browser. Unfortunately, malicious ads may also be inserted into the host webpage in this manner, creating an opportunity to damage a host website, or steal users' personal identifiable information. Additionally, a webpage host may be able to take advantage of an ad owner by manipulating the ad content inside the browser, such as by inflating the number of times an ad appears to have been clicked on by a user, for example.

As an example, it is not uncommon for a webmail system to host a third-party ad. The ad may be integrated by the ad syndicator in a way that allows the ad to freely expand out or fly around the host webpage. However, this ad also has a potential to view users' emails on the hosting page, and to steal user credentials from the host website's cookies, for example. From the perspective of protecting an ad owner, a host could charge an ad owner more where the host programmatically increases the number of times an ad appears to have been clicked on by a user.

Previous and current solutions to this ad serving security issue have limitations that may not make them as functional, or provide for extensive proprietary updates to user's, ad syndicator's, and advertiser's systems. In one such solution an ad created by the advertiser is sent by a third-party advertising vendor and put into a cross-domain frame or window of the host webpage, and the ad is isolated from the host webpage. However, there can be no client-side interaction with the host page, which may limit the ad's rich functionality. In another such solution, the ad created by the advertiser is pulled by the ad syndicator, transformed into pure text, and put into the host webpage. However, in this solution, the ad cannot contain executable code, which eliminates the ad's rich functionality. Other solutions utilize ad code scanning techniques, or “blacklisting” techniques that are designed to prohibit certain functions in the host webpage. However, these solutions may not be able to cover new malicious techniques, may block legitimate ads, and often require additional installs to browsers, or other ad syndication systems.

Based on the apparent lack of security coupled with the rich functionality issues, for example, many well known websites do not support online ad rendering other than text-based ads. Therefore, it may be desirable to be able to provide secure online ad rendering while providing rich functionality for ads, in order to provide websites with additional revenue streams, for example.

Techniques and systems are provided herein for securely serving online ads on a host webpage, while allowing for rich functionality of the online ads, but not the undesirable manipulation thereof by an unscrupulous host. The techniques and systems create an insulating cross-domain frame in a host webpage (e.g., a cross-domain inline frame (IFrame)), which contains a secure environment by default (e.g., content inside the frame cannot interact with the host webpage). The host webpage comprises insulator frame ad-space, which can be of a size that accommodates an initial size of ad content inside the cross-domain frame (e.g., the insulator frame space is the same height and width as the initial size of an ad to be inserted in the cross-domain frame). The insulator allows third party content (e.g., ad content from an ad syndicator) to be loaded into the insulating frame, based on parameters and restrictions preset by the host. The insulator contains source code that can detect specified events from the third party content (e.g., when a user mouses over an ad and the ad wishes to expand). When a specified event is detected inside the insulating frame, a communicator frame is created in the insulator frame, which can, for example, comprise a same domain IFrame (e.g., the communicator contains the same domain as the host webpage). The communicator, for example, can contain a request from the third party content (e.g., please expand the frame to accommodate expanded ad content), which can be forwarded to the host webpage in the form of a text message. The host webpage, for example, can validate the request and change the insulator frame to meet the request from the third party content. An API may be utilized that communicates a host's parameters and restrictions for an ad to be hosted in the cross-domain frame.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a block diagram illustrating an exemplary embodiment of current online ad serving on a host webpage.

FIG. 2 is a block diagram illustrating an exemplary embodiment of secure online ad serving on a host webpage.

FIG. 3 is a flow chart illustrating an exemplary method of secure serving of an online ad on a host webpage.

FIG. 4 is a block diagram illustrating an exemplary embodiment of a rendering of secure frame on a host webpage.

FIG. 5 is a block diagram illustrating an exemplary embodiment of communication between a secure frame and a host webpage.

FIG. 6 is a block diagram illustrating an exemplary embodiment of a secure frame expanding to accommodate interaction with an online ad.

FIG. 7 is a component block diagram illustrating an exemplary system for secure online ad rendering.

FIG. 8 is a component block diagram illustrating an exemplary embodiment of a system for secure online ad rendering.

FIG. 9 is an illustration of an exemplary computer-readable medium comprising processor-executable instructions configured to embody one or more of the provisions set forth herein.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

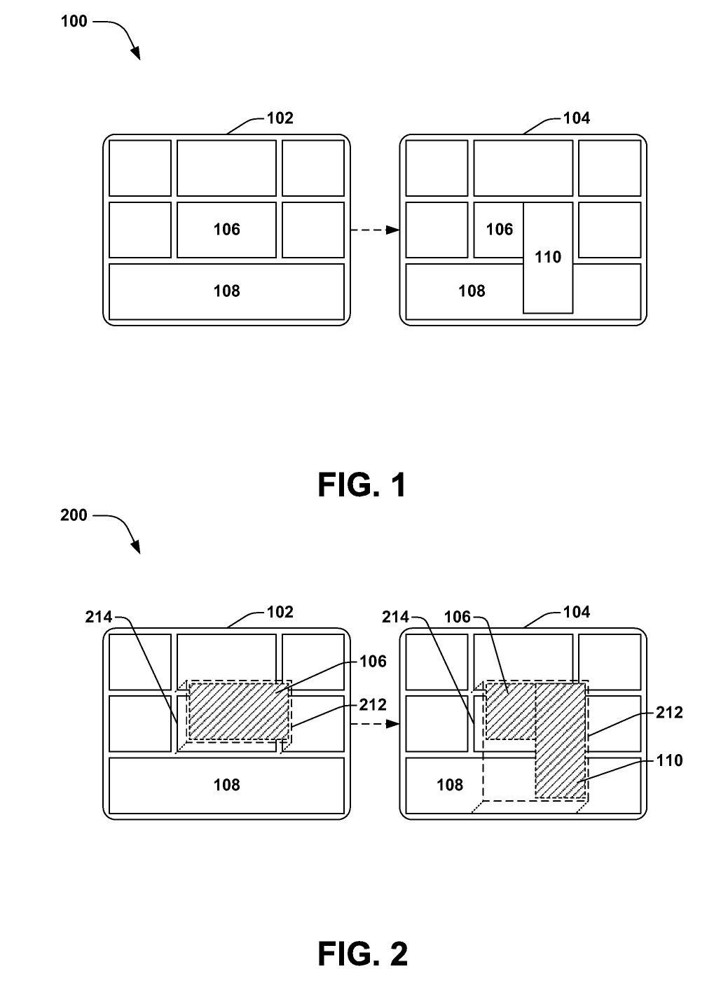

FIG. 1 is a block diagram illustrating an exemplary embodiment 100 of current online ad serving on a host webpage. In the exemplary embodiment 100, a host webpage 102 contains host content 108, and ad content 106 from a different domain than that of the host webpage 102. As an example, a host webpage 102 may call to an ad syndicator (e.g., an entity that provides online advertising services), which typically pulls an ad from an advertiser and puts the ad content 106 into the host webpage 102. The ad content 106 is typically inserted into the host webpage 102 so that a browser takes the ad content 106 as part of the host webpage 102. In this way, the ad content 106 may be allowed to freely interact with the host webpage for functionality, for example, allowing the ad to change its own size and position within the host webpage.

In FIG. 1, for example, when a user moves a cursor over the ad content 106, the ad expands 110 in the host webpage 104. The expanded ad content 110 covers over the host webpage content 108, in this example, as the browser considers the expanded ad content 110 to be part of the host webpage 104. In this exemplary embodiment of current online ad serving 100, an ad is granted respective privileges of the host webpage 104 in the browser. Therefore, ads that are “buggy” (e.g., do not work properly, will not close, shrink, etc.) or malicious (e.g., designed to steal personal information of users, or damage a host webpage), for example, may result in diminished or potentially harmful user experiences with the host webpage.

However, using the techniques and systems described herein, FIG. 2 illustrates an exemplary embodiment 200 of secure online ad serving on a host webpage. In the exemplary embodiment 200, a host webpage 102 contains ad space 214, which acts as a place holder for potential ads. In this embodiment, for example, an inline frame 212 (e.g., an inline, cross-domain frame comprising content from a different domain than that of the host webpage) can be inserted as a floating layer above the host webpage 102, aligned with the ad space 214. In this example, when the host webpage 102 calls to an ad syndicator to pull an ad from an advertiser, the ad content 106 can be inserted into the inline frame 212, instead of directly into the host webpage 102.

Because the ad content 106 is contained within the inline frame 212, for example, the ad may not be granted privileges of the host webpage 102 in the browser, thereby providing a more secure environment for the host webpage 102. However, referring to FIG. 2, if the ad content 106 is configured to expand 110 (e.g., upon a mouse over by a user) the inline frame 212 may need to expand to accommodate the expanded ad content 110 in the host webpage 104. In this example, a communicator frame (e.g., an IFrame with a same domain as the host webpage) may be created that allows the content in the inline frame 212 to communicate requests (e.g., to expand or move the inline frame) to the host webpage 104. Upon receiving such a request, for example, the host webpage 104 can programmatically expand the inline frame 212 to accommodate the expanded ad content 110, which can float over the host content 108. In this way, functionality of the ad content can be accommodated, while security of the host webpage 104 may be maintained.

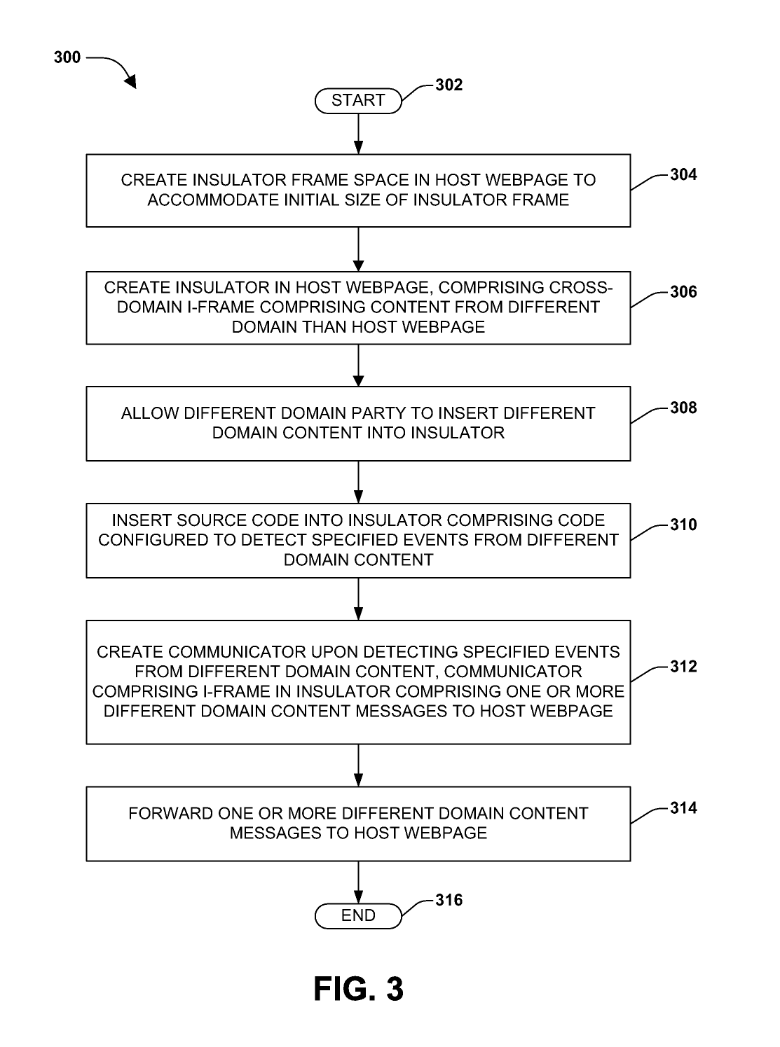

FIG. 3 is a flow chart illustrating an exemplary method 300 for secure serving of an online ad on a host webpage. The exemplary method 300 begins at 302 and involves creating insulator frame space in the host webpage to accommodate an initial size of an insulator frame, at 304. As an example, the host webpage may create insulator frame space comprising a specified width and height. In this example, the host webpage can call to an ad syndicator with the specified width and height, which can correspond to an initial width and height of an advertiser's ad content. In this way, the ad syndicator can pull only those ads that may have an initial width and height meeting the specifications of the host webpage. In this example, the insulator frame space will not contain host content, so as to avoid conflicts with ad content. Further, the frame created at 304 to contain the ad content can initially be configured to the specified size of the host ad-space.

At 306, an insulator is created that comprises a cross-domain IFrame in the host webpage, with the IFrame comprising content from a different domain than the domain of the host webpage. As an example, a cross domain inline frame (IFrame) may be configured to contain an online ad created and hosted by a different domain than that of the host webpage. Further, in this example, the IFrame can be configured to be substantially isolated from the host webpage so that content inside the IFrame may not interact with content outside the IFrame (e.g., the ad content may not manipulate the host webpage and/or content thereon).

At 308, a different domain party (e.g., a third party ad syndicator) is allowed to insert different domain content (e.g., ad content) into the insulator. In one embodiment, for example, the insulator may be created in such way as to allow an ad syndicator to control content inserted into the insulator. In this embodiment, the host page can provide specified parameters for the insulator, and the ad syndicator can pull ads from its catalogue that meet the host parameters and insert them into the insulator to be displayed on the host website.

At 310, source code is inserted into the insulator that comprises code configured to detect specified events from the different domain content. For example, ad content often has an ability to expand over a webpage when a user mouses over the content, or fly about a webpage to follow a user's movements. In this example, source code may be inserted into the insulator that detects when the ad content wishes to expand or move about the page, for example, when a user interacts with the content in a certain way.

At 312, upon detecting one or more specified events from the different domain content, a communicator is created in the insulator frame that comprises an IFrame (e.g., a same domain IFrame having a same domain as the host webpage), the IFrame comprising one or more messages from the different domain content to the host webpage. As an example, a communications IFrame can be created in the insulator cross-domain frame that allows ad content in the insulator frame to communicate requests to the host webpage. In this example, if the ad content in the frame is configured to expand when a user moves a cursor over the ad content, a communicator can be created that contains a request to the host to expand the frame to accommodate the expanded ad content.

At 314, the one or more messages from the different domain content are forwarded to the host webpage. In one embodiment, for example, the communicator may contain a text message for the host to expand the IFrame to accommodate the expanding ad content. In this example, because the communicator can have a same domain IFrame (e.g., from the same domain as the host), the text message can be passed onto the host webpage using the communicator.

Having forwarded the one or more messages to the host webpage, the exemplary method 300 ends at 316.

In one aspect, isolating third-party online ads from a hosting webpage and/or website can provide security for the host webpage from malicious attacks, and provide users with a positive and secure online experience. In this aspect, for example, a floating transparent cross-domain frame can be utilized in the host web-page to isolate the ad content from the host web-page. The cross-domain frame may be inserted inline (e.g., an IFrame) in the host webpage, which has a default property of disallowing interaction between the content inside the frame and the ad hosting web page. Communication from the ad content to the host webpage, for example, may be accomplished by means of a communicator frame in the insulator, as discussed above.

In this aspect, other related solutions to security of online ads (e.g., “BrowserShield,” “SafeScript,” “Google Caja”) utilize a “blacklisting” or a “whitelisting” method, whereby an ad is put into a same isolation boundary as a hosting webpage in a browser. In these related solutions, specified “unsafe” functionalities are then removed (blacklisted) from the ad content in the isolation boundary in the browser, or an ads' functionalities are restricted to a subset of what otherwise is provided by the browser to the ads by default (whitelisted). However, these solutions may not be attractive for ad syndicators, hosts and ad owners, as functionality can be reduced, and specific, proprietary updates may be necessary to the browser, and by the ad syndicator and ad owner.

Additionally, in this aspect, isolating third-party online ad content from a hosting webpage and/or website can provide security for the ad owner. The isolation techniques and systems, described herein, can inhibit the hosting website/webpage from programmatically manipulating the ad content inside the browser. For example, a webpage host may wish to forge user clicks (e.g., increase an amount of times user's (appear to) click on an ad) in order to increase an amount paid to the host by the ad owner (e.g., a type of click-fraud, whereby host's are paid more by ad owners when ads are clicked on more by users). In this way, a secure ad serving experience can be provided for both the host webpage and the ad owner or syndicator.

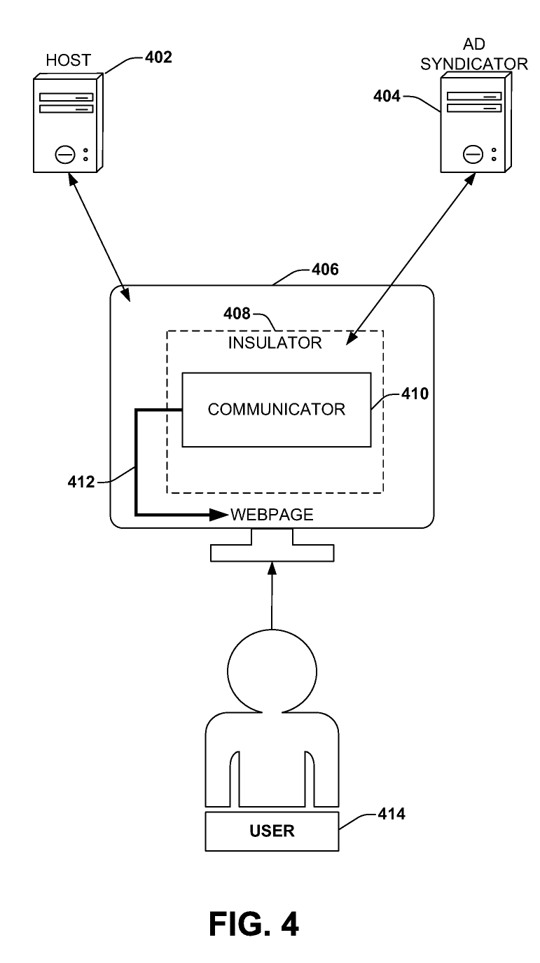

One embodiment of a use of an insulator cross-domain IFrame to isolate ad content is illustrated in FIG. 4. A website host 402 publishes a host webpage 406, for example, to the Internet, accessed and viewed by an online user 414. The website host 402 has all appropriate access and privileges for the host webpage 406. The host webpage 406 can, in this example, render an insulator IFrame 408 inside (inline) the host webpage 406. By default, content inside the insulator 408 cannot interact with the host webpage 406. In this example, the insulator 408 creates a substantial barrier between the IFrame's content and the host webpage 406, thereby mitigating malicious attacks originating from the frame's content, and mitigating a potential for the online user's 414 information being accessed by the frame's content.

An ad syndicator 404 may have a catalogue of ad content (e.g., from various ad owners) that is intended to be displayed on the host webpage 406. In this example, the ad content from the ad syndicator 404 is inserted into the insulator 408 in the host webpage 406. In this way, the ad syndicator 404 and the ad content may merely have access to content inside the I-frame 408, and can be barred from interacting with the host webpage 406. However, in this example, a communicator frame 410 may be created inside the insulator 408 to communicate requests 412 from the ad content to the host webpage 406, to aid in ad functionality, as discussed below.

In another aspect, ad content inside an insulator cross-domain IFrame may need to communicate with a host webpage. As an example, ad content that is configured to expand upon a specified event (e.g., a mouseover the ad content) may not be able to expand due to a fixed size of the cross-domain IFrame. However, in this example, if the ad content could communicate an intention to expand to the host webpage, the host webpage may programmatically expand the cross-domain IFrame to accommodate the expanded ad content.

In this aspect, a communicator IFrame (e.g., an IFrame having a same domain as the host webpage) can be created that may, for example, allow the different domain contents of the insulator frame to communicate requests to the host webpage. However, because security of the host webpage may still be a concern if the ad content is able to communicate with the host webpage, techniques can be employed that provide a validation step by the host webpage for any messages sent using the communicator. As an example, the communicator can be configured to only forward text message requests from ad content inside the insulator frame to the host webpage. In this example, the host webpage can validate the text requests against host parameters, set when the insulator frame was created, only allowing those requests that meet the preset limitations.

In one embodiment, the communicator may comprise a same domain IFrame (e.g., an IFrame having a same domain as that of the host webpage). In this embodiment, security measures may call for “white-listing” requests from content inside the insulator cross-domain IFrame. In this embodiment, only those functions the host webpage deems to be “safe” may be “white-listed” (allowed to run) in the frame. As an example, the host may only allow expansion of ad content to a certain size, and not allow moving of the frame around the page. The “white-listing,” in this example, has an advantage over “black-listing” of prior solutions, as there is less of an open surface (e.g., less potential methods for a malicious attack or unauthorized use of information) in “white-listing.” Using “white-listing,” the host webpage provides a limited list of allowable functions, whereas “blacklisting” provides a list of disallowed functions.

It will be appreciated that, the communicator is not limited to comprising a same domain IFrame. In other embodiments the communicator may, for example, utilize flash objects or a silverlight objects for communicating with the host webpage. It will be further appreciated that, while several examples of security measures have been discussed herein, the techniques described in this embodiment are not limited to any particular security measures. Those skilled in the art may devise additional methods and means for providing communications using a communicator, and security to the inter-frame communications channel.

In another aspect, events inside an insulator cross-domain frame inserted into a host webpage may be detected to determine functionality of the insulator and its contents. As an example, the source code may be inserted inside the insulator and used to detect events inside the insulator such as a user's cursor movements, cursor location, moving a cursor over an element in the insulator (mouseover, or mouse hover), or interacting with an element in the insulator. Additionally, the code in the insulator may be used, for example, to detect an ad content's user interface properties, that is, what types of functionality, display and interactive properties the ad content may have.

In this aspect, the source code inside the insulator can, for example, trigger the creation of the communicator frame, which can in turn be used to communicate requests to the host webpage, for example. In this way, as an example, change requests from the ad content, in response to events inside the insulator, may be communicated to the host webpage. As described above, the host webpage may receive the messages and institute appropriately requested changes to the insulator's properties, for example.

As an example, a user may move a cursor (mouse) from a position outside the insulator to a position over ad content inside the insulator. In this example, the source code inside the insulator can detect the cursor movement and location over the ad content, and it may receive a message from the ad content that this event results in the ad content expanding (e.g., or it may be a predetermined quality of the ad content, not needing a message). The source code inside the insulator can trigger the creation of the communicator, which can send a message to the host webpage, which can, in turn, change the insulator properties to accommodate the expanded ad content inside the insulator.

It will be appreciated that, while mouse and cursor events have been described in this embodiment, the techniques and systems, described herein, are not limited to these events and actions. In a computing environment, there are many varied events and actions that can occur on a webpage, and those skilled in the art may devise ways to detect these events and actions.

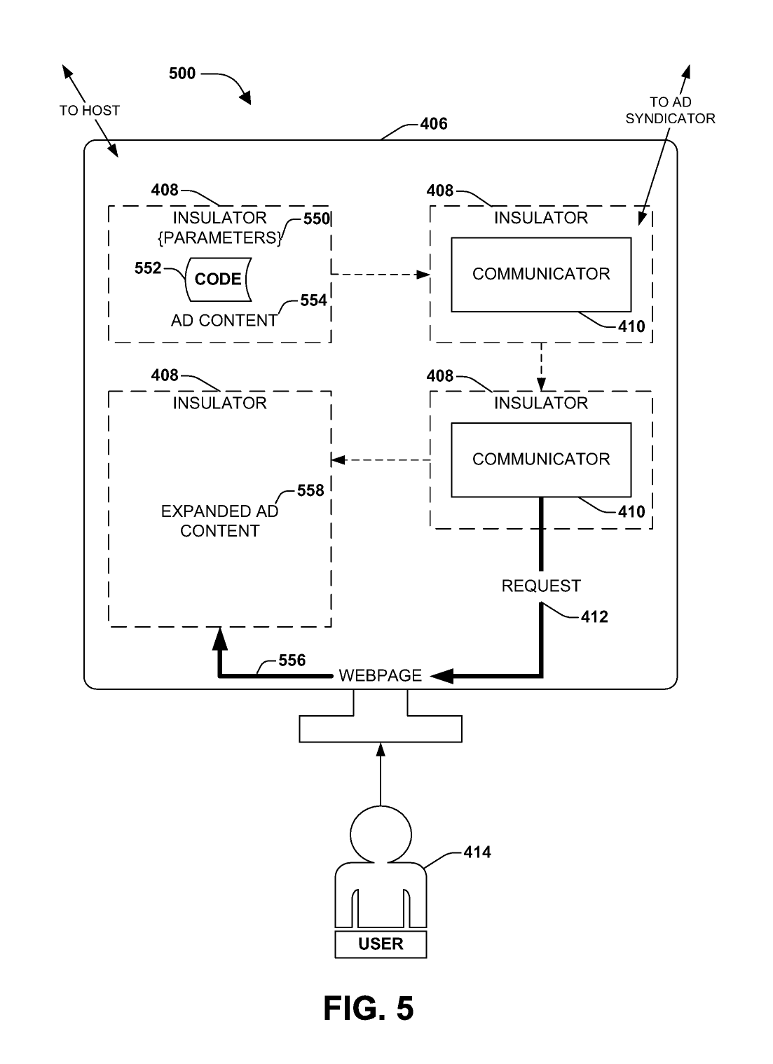

One embodiment one may use a same-domain communicator IFrame for communicating between different domain content, for example, and a host webpage, and source code for detecting specified events, is illustrated in FIG. 5. As previously illustrated in FIG. 4, now further detailed in the exemplary embodiment 500, a host webpage 406 communicates with a host website. In this example, the host website 406 comprises an insulator 408 that receives ad content 554 from an ad syndicator, based on host parameters 550 (e.g., size, events, functions). As described above, in order for the ad content 554 in the insulator 408 to communicate with the host webpage 406 a communicator 410 is created in the insulator 408 when a specified event is detected by the source code 552. The source code 552 is inserted into the insulator, which can detect specified events inside the insulator 408, as determined by the host parameters 550, and trigger creation of the communicator 410.

In this exemplary embodiment 500, a user 414 may interact with the ad content 554 (e.g., mouseover the ad content) in the insulator 408, which causes the ad content 554 to expand. However, the insulator 408 may have a size parameter 550 that limits the ad content's expansion. Therefore, in this embodiment, the code 552 can detect the expansion caused by the mouseover and trigger creation of the communicator 410. In this example, the communicator 410 can contain a text message that requests the host webpage 406 to expand the insulator 408, which is then forwarded 412 to the host webpage 406. The host webpage 406 can expand the insulator 556 to accommodate the expanded ad content 558.

Further, in this embodiment, the request 412 to the webpage 406 from the communicator 410 can be validated by the host. As an example, one of the “white-listed” functions may be communicating frame expansions to the host webpage 406. In this example, because the function called by the ad content is “white-listed” the host webpage 406 can validate the request and, for example, programmatically expand the insulator 408 to accommodate the expanded ad content 558.

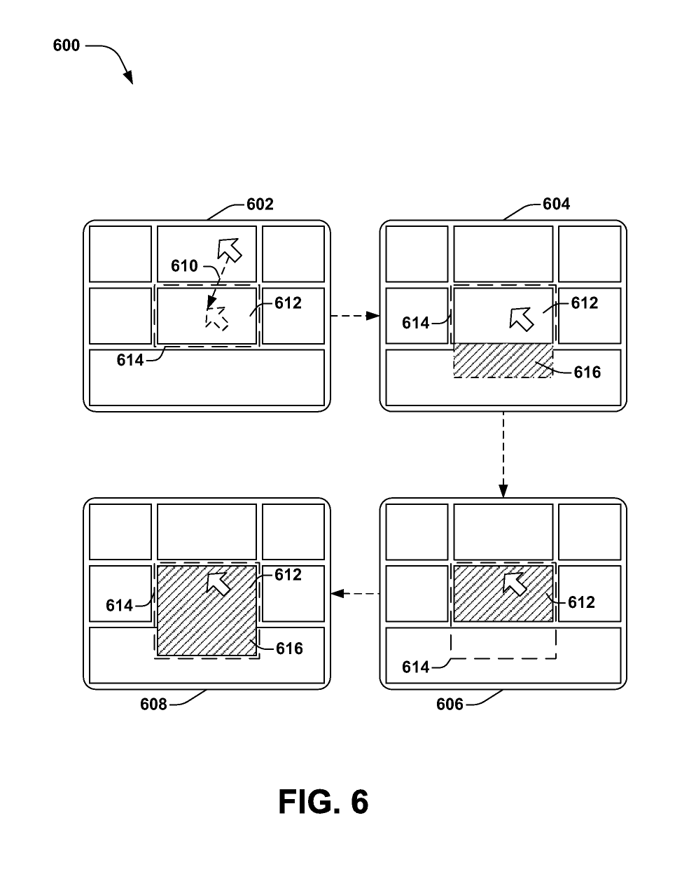

FIG. 6 is an exemplary embodiment 600 of a secure frame expanding to accommodate interaction with an online ad. In this example, a user moves a cursor 610 over the ad content 612 in the insulator 614. The ad content 612, in this example, is configured to expand downward when it detects the cursor moving 610 over the ad content 612. As seen in the host webpage 604, upon detecting the mouseover event 610, the ad content expands 616, however, because the ad content 612 is limited to display only inside the insulator 614, the expanded ad content 616 cannot be viewed by the user.

In this example, as seen in the host webpage 606, the source code inside the insulator detects the ad content's intended expansion, which triggers creation of a communicator. The communicator sends an expansion request to the host webpage, which validates the request and expands the insulator 614 to a size that can accommodate the expanded ad content. Once the insulator 416 expands, the expanded ad content 616 can be viewed by a user in the website 608. It will be appreciated that the expansion and movement of the IFrame, in this example, can occur rapidly so that, as viewed by the user, the ad content merely expands downward.

In another aspect, the host webpage can use a source code interface for communicating parameters, restrictions, and allowable events for the different domain content to the third party loading the different domain content. In one embodiment, for example, the source code interface may be one or more application programming interfaces (APIs) comprising various parameters and/or allowable events related to displaying ad content on the host webpage. In this embodiment, the one or more APIs can have a query to a code string used to display the different domain content. For example, the query may contain a URL for an ad syndicator that can load ad content from their catalogue of ads. Further, in this example, the API may have parameters corresponding to the ad content's parameters, as configured by the host, which can define a size, expansion size, and movement restrictions of the ad content. Additionally, in this example, the API may comprise specified events for the different domain content, as configured by the host, which can define allowable events such as ad content expansion or movement on the host webpage

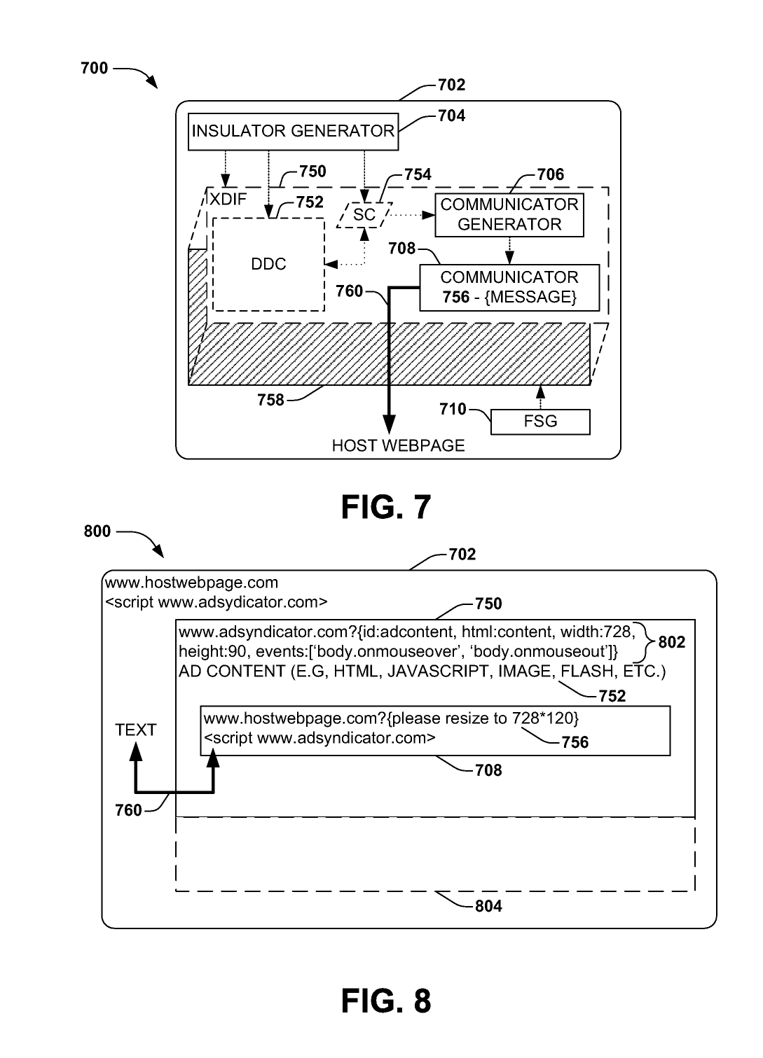

A system may be devised for securely rendering online ads on a webpage. FIG. 7 illustrates one embodiment of an exemplary system 700 for a host webpage to host and render content from a different domain than that of the host. In the exemplary embodiment 700 a host webpage 702 has an instance of an insulator generator 704 installed thereon, which is configured to create a cross-domain IFrame 750 in the host webpage 702. Further, the insulator generator 704 can be configured to allow a different domain party to insert different domain content 752 into the cross-domain IFrame 750. Additionally, the insulator generator 704 can be configured to insert source code 754 into the cross-domain IFrame 750, and the source code 754 can be configured to detect specified events from the different domain content 752.

As an example, the insulator generator 704 may be in the form of source code installed in a host webpage 702. In this example, the insulator generator 704 can create an insulator cross-domain IFrame 750 that contains a script reference to a third party ad syndicator, and the ad syndicator can be allowed to load ad content from a different domain 752 into the insulator 750. Further, in this example, source code 754 can be inserted into the insulator 750 that can detect when the ad content 752 wishes to expand or move about the host webpage 702.

In the exemplary embodiment 700, an instance of a frame space generator 710 is installed on the host webpage 702. The frame space generator 710 can be configured to create insulator frame space 758 in the host webpage 702 that can accommodate an initial size of the insulator cross-domain IFrame 750. As an example, a host webpage 702 may contain a variety of host content intended to be viewed by webpage viewers. In this example, in order for the host to display ad content from a different domain 752, space can be created inside the host webpage that contains no host content 758. In this way, an IFrame may “float over” the frame space 758 in the host webpage 702, and not obscure host content from the users.

In the exemplary embodiment 700, an instance of a communicator generator 706 is installed in the insulator cross-domain IFrame 750. The communicator generator 706 is configured to create a communicator 708 (e.g., a same-domain IFrame) upon a detection of one or more specified events from the different domain content 752. Further, the communicator generator 706 can be configured to insert one or more different domain content messages 756 in the communicator same-domain IFrame 708, for example, resulting from the one or more specified events. Additionally, the communicator generator 706 can be configured to forward 760 the one or more different domain content messages 756 to the host webpage.

As an example, a webpage user may move a cursor over ad content from a different domain 752, which can trigger the ad content to expand. In this example, the expansion of the ad content may be an allowable event that is detected by the source code 754, which, in turn, can trigger the communicator generator 706 to create a communicator IFrame 708 (e.g., an IFrame having a same domain as the host webpage). Further, in this example, the communicator generator can insert a message 756 into the communicator 708 that requests the host to expand the insulator 750, in order to accommodate the ad content expansion. This text message can be forwarded 760 to the host webpage, for example, where it may be acted upon accordingly.

It will be appreciated that, while the exemplary embodiment 700 illustrates a use of the system components as instantiations in the host webpage and insulator, the exemplary system is not limited to this configuration. In one embodiment, the insulator generator may be software programming that is part of a program for creating webpages, or part of a website development package. In another embodiment, the communicator generator may be source code created inside the cross-domain IFrame by the insulator generator.

In one aspect, the insulator cross-domain IFrame 750 may comprise host parameters that are configured to limit a size of different domain content 752 (e.g., ad content), and limit the types of events allowed in the IFrame. In one embodiment, for example, the insulator cross-domain IFrame 750 may comprise a parameter set that describes an ad content's allowable: maximum height and width; initial height and width; minimum height and width; a list of event names on which to detect a change; and a height and width of frame space in the host webpage. In this embodiment, the source code 754 installed in the insulator cross-domain IFrame 750 can be configured to detect the list of event names in the parameter set. As an example, if ad content wished to move about the host webpage, and this event was listed in the parameter set, the source code can detect when the ad content wished to move and trigger a creation of the communicator generator 706.

FIG. 8 illustrates an example of one embodiment 800 of the system described above. In the exemplary embodiment 800, a host webpage 702 comprises an insulator cross-domain IFrame 750. The insulator 750 comprises URL script 802 that includes the URL for an ad syndicator, and parameters for the restrictions and events allowed in the insulator 750. For example, the ad syndicator ‘www.adsyndicator.com’ can be allowed to load ad content from a different domain 752 into the insulator. In this example, the ad content 752 is selected to have a width of 728 and a height of 90, and is limited to mouseover and mouseout events. In the exemplary embodiment 800, if an event is triggered (e.g., a mouseover of the ad content body) a communicator IFrame 708 is created in the insulator 750. In this example, the communicator can have a same domain as the host webpage (www.hostwebpage.com), and includes a message 756 request that the host webpage resize the insulator to 728 by 120 (e.g., to accommodate expanded ad content). The request is forwarded to the host webpage 760, in the form of a text message. The host webpage, for example, can validate the text request to determine if the requested action is allowed, and act upon the request accordingly.

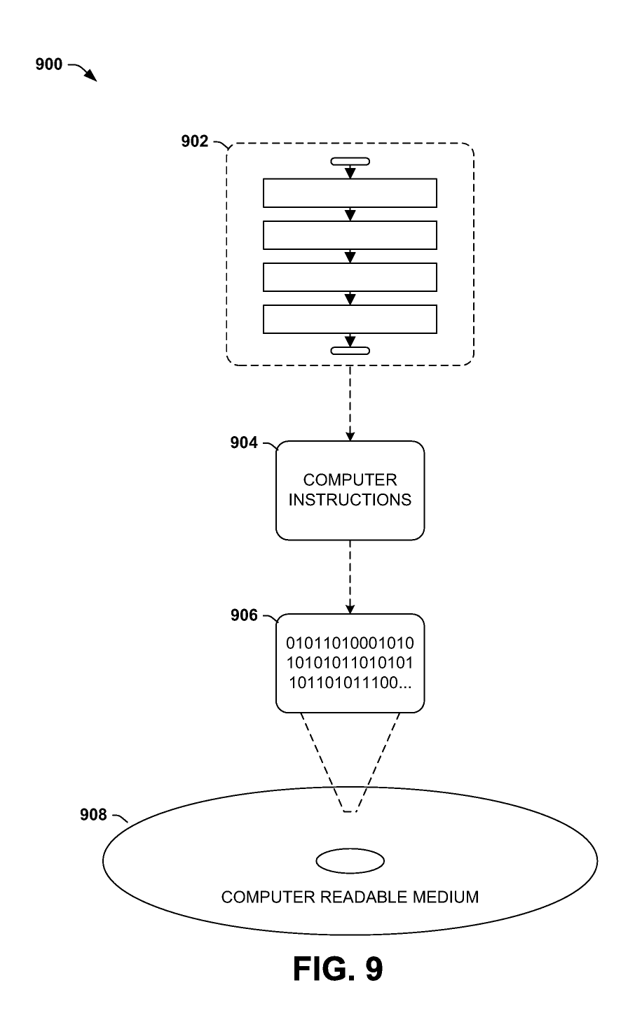

Still another embodiment involves a computer-readable medium comprising processor-executable instructions configured to implement one or more of the techniques presented herein. An exemplary computer-readable medium that may be devised in these ways is illustrated in FIG. 9, wherein the implementation 900 comprises a computer-readable medium 908 (e.g., a CD-R, DVD-R, or a platter of a hard disk drive), on which is encoded computer-readable data 906. This computer-readable data 906 in turn comprises a set of computer instructions 904 configured to operate according to one or more of the principles set forth herein. In one such embodiment 900, the processor-executable instructions 904 may be configured to perform a method, such as the exemplary method 300 of FIG. 3, for example. In another such embodiment, the processor-executable instructions 904 may be configured to implement a system, such as the exemplary system 700 of FIG. 7, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

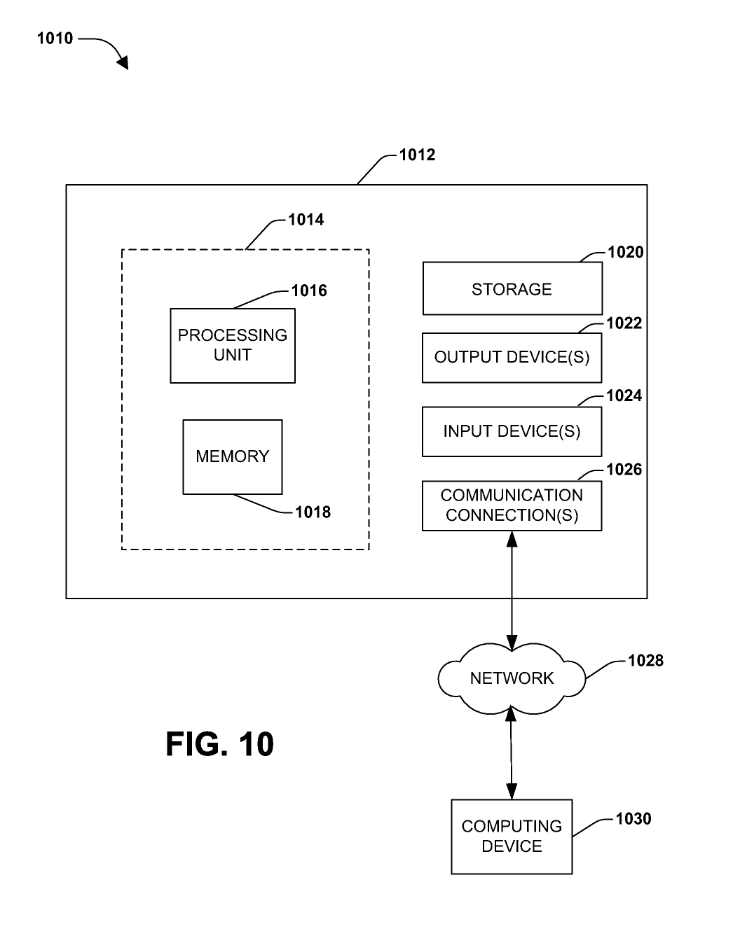

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 122 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for rendering online ads on a webpage, comprising:
creating insulator space in the host webpage to accommodate an initial size of an insulator frame;
creating an insulator in a host webpage, the insulator comprising a cross-domain IFrame comprising content from a different domain than a host webpage's domain;
allowing a different domain party to insert different domain content into the insulator;
inserting source code into the insulator comprising code configured to detect specified events from the different domain content;
creating a communicator upon detecting specified events from the different domain content, the communicator in the insulator comprising one or more different domain content messages; and
forwarding the one or more different domain content messages to the host webpage.

2. The method of claim 1, creating the insulator in a host webpage using host parameters.

3. The method of claim 2, the host parameters comprising one or more of:
a maximum width of the different domain content;
a maximum height of the different domain content;
an initial height of the different domain content;
an initial width of the different domain content;
a minimum height of the different domain content;
a minimum width of the different domain content;
a list of event names on which to detect a change of the different domain content;
a height of a space in the host webpage that the different domain content can occupy; and
a width of the space in the host webpage that the different domain content can occupy.

4. The method of claim 1, the communicator comprising a same domain IFrame comprising a same domain as the host webpage.

5. The method of claim 1, comprising the host webpage validating the one or more messages from the communicator prior to making changes in the host webpage.

6. The method of claim 5, forwarding the one or more messages comprising forwarding one or more text messages requesting specified parameter changes to the insulator to accommodate the different domain content.

7. The method of claim 6, comprising the host webpage adjusting the parameters of the insulator for the different domain content based on the one or more messages from the different domain content.

8. The method of claim 7, adjusting the parameters of the insulator comprising one or more of:
resizing the insulator within the host webpage; and
moving the insulator within the host webpage.

9. The method of claim 1, comprising the insulator creating the communicator inside the insulator upon detection of the one or more specified events.

10. The method of claim 9, an event comprising one or more:
expansion of the different domain content; and
moving of the different domain content on the host webpage.

11. The method of claim 1, the different domain content comprising ad content provided by an ad syndicator.

12. The method of claim 1, comprising the host webpage using a source code interface for communicating different domain content parameters and restrictions to the different domain.

13. The method of 12, using a source code interface comprising using one or application program interfaces (APIs) comprising one or more of:
a query to a code string for loading different domain content;
the different domain content's parameters as configured by the host; and
the different domain content's events as configured by the host.

14. A system for rendering online ads on a webpage, comprising:
an insulator generator configured to:
create a cross-domain IFrame in a host webpage;
allow a different domain party to insert different domain content into the cross-domain IFrame; and
insert source code into the cross-domain IFrame, configured to detect specified events from the different domain content;
a frame-space generator, configured to create space in the host webpage that can accommodate an initial size of the cross-domain IFrame; and
a communicator generator configured to create a communicator upon the detecting of specified events from the different domain content, the communicator in the cross-domain IFrame configured to:
insert one or more different domain content messages in the same-domain IFrame; and
forward the one or more different domain content messages to the host webpage.

15. The system of claim 14, the insulator generator comprising host parameters configured to limit a size and events of different domain content in the cross-domain IFrame.

16. The system of claim 15, the host parameters comprising one or more of:
a maximum width of the different domain content;
a maximum height of the different domain content;
an initial height of the different domain content;
an initial width of the different domain content;
a minimum height of the different domain content;
a minimum width of the different domain content;
a list of event names on which to detect a change of the different domain content;
a height of a space in the host webpage that the different domain content can occupy; and
a width of the space in the host webpage that the different domain content can occupy.

17. The system of claim 16, the source code in the cross-domain IFrame configured to detect events on the list of event names on which to detect a change of the different domain content.

18. The system of claim 14, the insulator generator configured to allow an ad syndicator to insert the different domain content in the insulator

19. The system of claim 14, comprising a source code interface comprising:
a header comprising a URL of an ad syndicator
a parent node comprising the different domain content parameters; and
global configurations comprising the different domain content restrictions.

20. A method for rendering online ads on a webpage, comprising:
creating frame-space in the host webpage to accommodate an initial size of an insulator frame;
a host webpage creating an insulator in the host webpage, the insulator comprising a cross-domain IFrame comprising:
parameters for the insulator comprising:
size parameters;
content restriction parameters: and
content event parameters; and
ad content from a different domain than a host webpage's domain;
loading the ad content from a different domain into the insulator from inside the insulator;
inserting source code into the insulator comprising code configured to detect if specified events from the ad domain content, the specified events comprising one or more of:
the ad content wanting to expand in the host webpage; and
the ad content wanting to move around the host webpage;
upon detecting specified events creating a communicator, the communicator comprising a same domain IFrame in the insulator comprising one or more ad content requests; and
the communicator forwarding the one or more ad content requests to the host webpage, the ad content requests comprising text messages.
